(19) United States
(12) Patent Application Publication
(10) Pub. No.: US 2004/0055767 A1
(43) Pub. Date: Mar. 25, 2004

(54) Vehicle mounted fire suppression system

(75) Inventor: Mark Hayes, Calgary (CA)

Correspondence Address: OGILVY RENAULT, 1981 MCGILL COLLEGE AVENUE, SUITE 1600, MONTREAL, QC, H3A2Y3, CA

(73) Assignee: Just-In Case Fire Ltd., Calgary (CA)

(21) Appl. No.: 10/375,178

(22) Filed: Feb. 28, 2003

Related U.S. Application Data
(63) Continuation-in-part of application No. 10/251,796, filed on Sep. 23, 2002.

(51) Int. Cl. A62C 3/07

(52) U.S. Cl. 169/62

(57) ABSTRACT

A fire extinguishing system for a vehicle includes a pump, fire suppression agent, hose, and a container for retaining water. The system is mounted within a vehicle, an example of which may be a passenger vehicle and may be powered by the vehicle or extraneously. The provision for all of the necessary elements facilitates containment and extinguishment of serious fires involving the vehicle or adjacent the vehicle.

### CROSS-REFERENCE TO RELATED APPLICATIONS

This application is a Continuation-In-Part of U.S. patent application Ser. No. 10/251,796, filed Sep. 23, 2002.

### FIELD OF THE INVENTION

The present invention relates to a portable fire suppression system and more particularly, the present invention relates a portable fire suppression system which is mounted within a vehicle for immediate use in an emergency situation.

### BACKGROUND OF THE INVENTION

There are a broad range of devices and methods for extinguishing fires in various situations. Some of these systems are more useful than others at fire suppression. As an example, U.S. Pat. No. 5,590,718, issued Jan. 7, 1997, to Bertossi discloses an anti-fire system for vehicles. The arrangement relies on the use of an existing fire extinguisher and employs an elongate tube to extend the length of the tube and nozzle incorporated with the extinguisher. A valve and sensor are also provided with the apparatus:

Bertossi's device is useful, however, it is limited to the volume of the extinguishing agent. Where a larger or more serious fire occurs, significant amounts of fire suppressant agent are required.

Vician, in U.S. Pat. No. 6,257,340, discloses a rapid acting fire extinguishing system. A series of shock tubes are connected, at least one of which has high pressure fluid therein. A second tube contains a volatile fire extinguishant. A diaphragm isolates the tubes. Upon actuation of the system, the tubes work together to produce a pressurized extinguishant subsequently discharged by a nozzle.

There are numerous types of fire extinguishing systems in the art, however, portable, mobile systems which having adequate capacity to handle larger fires is required. The present invention addresses this requirement and provides a ready to use high capacity arrangement.

### SUMMARY OF THE INVENTION

One object of the present invention is to provide an improved apparatus for emergency use in a vehicle fire or for use about the perimeter of the vehicle to extinguish fires which may exceed the capacity of a conventional portable extinguisher.

A further object of one embodiment of the present invention is to provide a vehicle fire extinguishing system comprising, in combination:

a vehicle; and

a fire suppression system, including:

a fire suppressing agent;

container means for retaining a supply of water in the vehicle;

a pump for pumping a mixture of the water and the fire suppressing agent;

a flexible conduit for connection with the pump, the conduit for dispensing the mixture; and

power means for connecting the pump to a source of power for driving the pump.

The use of the system in a vehicle has been found to be of particular use. Generally, small refillable fire extinguishers are fairly limited in size and thus volume of fire suppressing agent. This does not present any problem in situations where the fire is relatively minor, however, in more significant fires, the effectiveness of these is limited. The provision for power assistance with the technology set forth herein allows for high pressure mixing with the fire suppressant material and therefore maximum efficiency in dispensing the material. In the event that the vehicle is inoperable, the system may be connected to an extraneous power source or another vehicle.

In view of the fact that the system provides an “on-board” source of water, the device may be used at any time in any location.

As a fire suppressant agent, Flame-Out™ may be used. This material has proven very effective to combat fires and requires a very small volume of water to effect excellent results.

One of the major drawbacks of portable fire extinguishers is low volume. Essentially, these are designed for quick action to relatively small fires at inception. Once the blaze is beyond the initial stages, the extinguishers have little, if any, value.

Having thus generally described the invention, reference will now be made to the accompanying drawings, illustrating preferred embodiments.

### BRIEF DESCRIPTION OF THE DRAWINGS

FIG. 1 is a schematic illustration of one embodiment of the invention.

It will be noted that throughout the appended drawings, like features are identified by like reference numerals.

### DETAILED DESCRIPTION OF THE PREFERRED EMBODIMENT

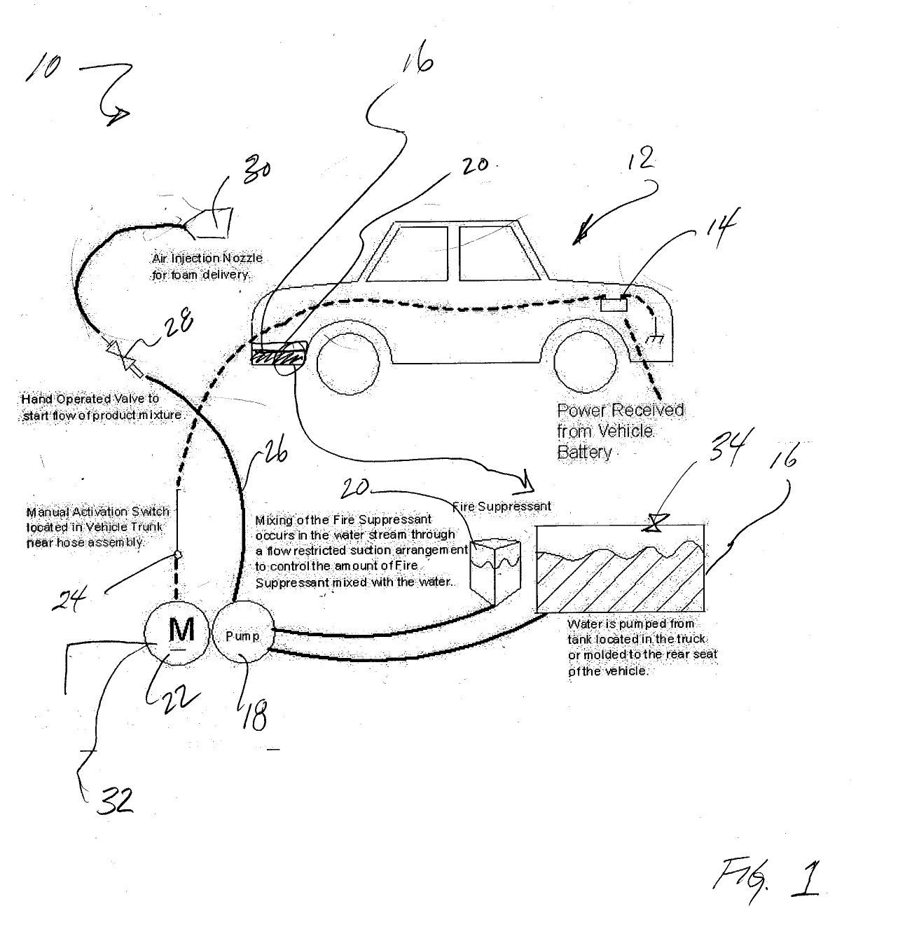

Referring now to FIG. 1, the system is referenced by numeral 10. A vehicle,12, shown in the example as a passenger car includes a conventional battery 14 for providing power to the system.

The vehicle 12 includes a container 16 for retaining a supply of water. The container 16 is removably mounted within the vehicle to facilitate refilling, repair etc. The container 16 is connected to a pump 18, which pump 18 is also connected to a supply of fire suppressant material 20. Successful results have been obtained using Flame-Out™ which requires very small amounts of water. A motor 22 drives the pump 20 and is connected to battery 14. A switch 24 is provided for operation of motor 22.

A length of conduit 26 has a hand operated valve 28 and terminates in nozzle 30.

As alternatives, the motor 22 may provide for an auxiliary port 32 for connection to an alternate source of power or another car battery. Further, container 16 may include a secondary valve 34 for connection to a similar container in another vehicle (not shown) or some other form of water supply.

It will be appreciated to those skilled in the art that the vehicle may comprise any vehicle such as a boat, passenger car, truck, bus, aircraft inter alia.

Although embodiments of the invention have been described above, it is not limited thereto and it will be apparent to those skilled in the art that numerous modifications form part of the present invention insofar as they do not depart from the spirit, nature and scope of the claimed and described invention.

I claim:

1. A vehicle fire extinguishing system comprising, in combination:
a vehicle; and
a fire suppression system, including:
a fire suppressing agent;
container means for retaining a supply of water in said vehicle;
a pump for pumping a mixture of said water and said fire suppressing agent;
a flexible conduit for connection with said pump, said conduit for dispensing said mixture; and
power means for connecting said pump to a source of power for driving said pump.

2. The apparatus as set forth in claim 1, wherein said apparatus is self-contained.

3. The apparatus as set forth in claim 1, wherein said conduit comprises a flexible hose.

4. The apparatus as set forth in claim 1, wherein said pump is mounted within said vehicle.

5. The apparatus as set forth in claim 1, wherein said source of power comprises a power source of said vehicle.

6. The apparatus as set forth in claim 5, wherein said source of power comprises a battery of said vehicle.

7. The apparatus as set forth in claim 1, wherein said source of power comprises the alternator of said vehicle.

8. The apparatus as set forth in claim 5, wherein said source of power comprises a source extraneous of said vehicle.

9. The apparatus as set forth in claim 1, wherein said fire suppressing agent is stored in a refillable container in said vehicle.

10. The apparatus as set forth in claim 1, wherein said fire suppression system is mounted in the trunk of said vehicle.

11. The apparatus as set forth in claim 1, wherein said fire suppression system includes a refillable container mounted under a seat portion of said vehicle.

12. The apparatus as set forth in claim 1, wherein said vehicle comprises a vehicle selected from the group consisting of a passenger car, a truck, a bus, a train an aircraft, and a recreational vehicle.
